(19) United States
(12) Patent Application Publication
(10) Pub. No.: US 2013/0140975 A1
(43) Pub. Date: Jun. 6, 2013

(54) SPARK PLUG

(71) Applicants: Haruki Yoshida, Tajimi-shi (JP); Toshitaka Honda, Nagoya (JP); Akira Suzuki, Nagoya (JP)

(72) Inventors: Haruki Yoshida, Tajimi-shi (JP); Toshitaka Honda, Nagoya (JP); Akira Suzuki, Nagoya (JP)

(21) Appl. No.: 13/816,567

(22) PCT Filed: Sep. 16, 2011
(86) PCT No.: PCT/JP2011/005238

§ 371 Date: Feb. 12, 2013

(30) Foreign Application Priority Data
Oct. 1, 2010 (JP) 2010-224266

(51) Int. Cl. H01T 13/02

(52) U.S. Cl. CPC H01T 13/02
USPC 313/135

(57) ABSTRACT

A spark plug having excellent load life performance even when the spark plug receives an impact or vibration. The spark plug includes an accommodated portion of a metallic terminal, which is accommodated in an axial hole of an insulator, having a plurality of bent portions formed as a result of proper bending of the accommodated portion. The bent portions are in close vicinity to an inner circumferential surface of the insulator at three or more locations, and are present without localizing in the radial direction of the axial hole.

### FIELD OF THE INVENTION

The present invention relates to a spark plug used for igniting an internal combustion engine. Specifically, the present invention relates to a spark plug having a resistor incorporated therein.

### BACKGROUND OF THE INVENTION

In general, a spark plug used for igniting an internal combustion engine such an automotive engine includes a tubular metallic shell; a tubular insulator disposed in the bore of the metallic shell; a center electrode disposed in a forward end portion of the axial hole of the insulator; a metallic terminal disposed in a rear end portion of the axial hole; and a ground electrode whose one end is joined to the forward end of the metallic shell and whose other end faces the center electrode so as to form a spark discharge gap. Further, there has been known a spark plug including a resistor which is disposed in the axial hole between the center electrode and the metallic terminal so as to prevent generation of radio noise.

In general, such a resistor is formed from a mixture of glass powder and an electrically conductive substance such as carbon black powder or metal powder. However, since the amount of metal contained in the resistor is not so large, difficulty is encountered in joining the resistor directly to the metallic terminal and the center electrode, which are formed of metal. In order to eliminate the difficulty, in general, a seal layer containing a metal powder in a relatively large amount is disposed between the metallic terminal and the resistor and between the center electrode and the resistor to thereby increase the joint strength therebetween.

Incidentally, recent internal combustion engines for automobiles or the like have been required to produce a higher power and to operate with a higher efficiency, and development of a spark plug of a reduced size has been demanded in order to allow free design of engines and a reduction in the size of engines themselves. In order to reduce the size of a spark plug, the diameter of the insulator must be decreased. Meanwhile, in order to secure the desired characteristics such as mechanical strength of the insulator, the insulator must have a predetermined thickness in the radial direction. Accordingly, in order to reduce the diameter of the insulator, the diameter of the bore of the insulator must be decreased. However, when the diameter of the bore of the insulator is decreased, the diameters of the resistor and the seal layer also decrease. In such a case, the joint strength between the resistor and the seal layer decreases, and when an impact or vibration acts on the spark plug, a crack is generated at the interface between the resistor and the seal layer, which may result in deterioration of load life performance.

A spark plug which can solve such a problem is disclosed in, for example, Japanese Patent Application Laid-Open (kokai) No. 2009-245716 (“Patent Document 1”). In claim 1 of Patent Document 1, there is recited a “spark plug characterized in that the diameter D of the electrically conductive glass seal layer is 3.3 mm or less, and the joint surface between the electrically conductive glass seal layer and the resistor is formed to have a curved shape.” Patent Document 1 states that, the invention can provide a “spark plug which is enhanced in adhesion between the resistor and the electrically conductive glass seal layer, which is excellent in vibration resistance and load life performance of the resistor, and which has a reduced diameter” (see paragraph 0012).

### SUMMARY OF THE INVENTION

### Problems to be Solved by the Invention

An object of the present invention is to provide a spark plug which is excellent in load life performance even when it receives an impact or vibration.

### Means for Solving the Problems

Means for solving the above-described problems is as follows.

(1) A spark plug comprising:

an insulator having an axial hole extending in a direction of an axis;

a center electrode held at one end of the axial hole;

a metallic terminal which has an accommodated portion accommodated in the axial hole and which is held at the other end of the insulator; and

a connecting portion which electrically connects the center electrode and the metallic terminal within the axial hole, the spark plug being characterized in that

the side of the axial hole where the metallic terminal is held is defined as a rear end side with respect to the direction of the axis;

a connection member which constitutes the connecting portion is provided between an outer circumferential surface of a forward end portion of the accommodated portion and an inner circumferential surface of the insulator; and

in sectional images orthogonal to the axis which are captured at intervals of 0.5 mm from a rear end of the accommodated portion toward a forward end thereof up to a rear end position where the connection member is present,

on a sectional image Sₙ at the n-th section (n is a natural number) counted from the rear end of the accommodated portion,

a center of the accommodated portion is defined as a point aₙ, a center of the axial hole is defined as a point Oₙ, a line which passes through the points aₙ and Oₙ is defined as a line Lₙ, a diameter of the axial hole is represented by 2Rₙ, a diameter of the accommodated portion is represented by 2rₙ, a distance between the point aₙ and the point Oₙ is represented by Hₐₒₙ, and the point aₙ which satisfies a relation Hₐₒₙ≧0.8(Rₙ−rₙ) is defined as a point Aₙ,

on the sectional image S₁,

a line which is obtained by rotating a line L₁ by 45° about the point O₁ is defined as a line L₁₊, a line which is obtained by rotating the line L₁ by −45° about the point O₁ is defined as a line L₁₋, four areas which are surrounded by a plane X₊ containing the line L₁₊ and the axis, a plane X₋ containing the line L₁₋ and the axis, and the inner circumferential surface of the insulator are identified by T₁, T₂, T₃, and T₄, respectively, and

when successive points Aₘ to A₍ₘ₊ₖ₎ (m and k are natural numbers) are present in a specific area selected from the areas T₁, T₂, T₃, and T₄, a group containing these points Aₘ to A₍ₘ₊ₖ₎ is defined as a group B_{m,y}, where y is a natural number and means that the group is the y-th group counted from the rear end side of the accommodated portion,

wherein the maximum value of y is at least 3, and at least two of the groups B_{m,y} are present in two areas which are selected from the areas T₁ to T₄ and which are located at symmetrical positions.

Preferred modes of the means (1) are as follows:

(2) an inter-bend distance D, which is a distance along the direction of the axis between a sectional image containing a point Aₛ (the first point Aₙ counted from the rear end of the accommodated portion) and a sectional image containing a point Aₑ (the last point Aₙ counted from the rear end of the accommodated portion) is 5 mm or greater;
(3) the groups B_{m,y} are present in at least three areas selected from the areas T₁ to T₄;
the maximum value of y is at least 4;
(5) the groups B_{m,y} are present in all the areas T₁ to T₄;
(6) the maximum value of y is at least 5;
(7) an intermediate-diameter portion diameter, which is a diameter of the axial hole (2) at a position where the forward end portion (20) is disposed, is 2.9 mm or less;
(8) the inter-bend distance D is 7 mm or greater; and
(9) the inter-bend distance D is 10 mm or greater.

### Effects of the Invention

In the spark plug of the present invention, the maximum value of y is at least 3, and at least two of the groups B_{m,y} are present in two areas which are selected from the areas T₁ to T₄ and which are located at positions symmetrical to each other. Therefore, there can be provided a spark plug which is excellent in load life performance even when it receives an impact or vibration. In other words, a plurality of bent portions formed as a result of proper bending of the accommodated portion are in close vicinity to the inner circumferential surface of the insulator at three or more locations, and are present without localizing in the radial direction of the axial hole. Therefore, when the spark plug receives an impact or vibration, the plurality of bent portions in close vicinity to the inner circumferential surface of the insulator serve as fulcrums to thereby suppress vibration of the accommodated portion. Therefore, the vibration of the accommodated portion is not transmitted to the connecting portion, and it is possible to prevent generation of a crack at the boundaries between the resistor and the first and second seal layers, which constitute the connecting portion. As a result, the resistance of the connecting portion does not increase sharply. Therefore, there can be provided a spark plug which is excellent in load life performance even when it receives an impact or vibration.

In the spark plug of the present invention, the distance in the axis direction between a sectional image containing the point Aₛ and a sectional image containing the point Aₑ is at least 5 mm. Therefore, of the above-described plurality of bent portions, two bent portions located at opposite ends thereof separate from each other by a predetermined distance in the axial direction. Thus, vibration of the accommodated portion can be suppressed to a greater degree. As a result, the spark plug has improved load life performance after it receives an impact or vibration.

In the spark plug of the present invention, when the intermediate-diameter portion diameter is 2.9 mm or less, the effect of improving load life performance is enhanced.

### BRIEF DESCRIPTION OF THE DRAWINGS

FIG. 1 is an explanatory view showing a cross section of the entirety of a spark plug which is one embodiment of a spark plug according to the present invention.

FIG. 2 is an explanatory view showing a cross section of a main portion of the spark plug which is one embodiment of the spark plug according to the present invention.

FIG. 3 is an explanatory view showing a sectional image S₁ of the spark plug shown in FIG. 2 taken along line I₁-J₁.

FIGS. 4A-4C are explanatory views showing sectional images in which sectional images Sₙ of the spark plug shown in FIG. 2 taken along lines Iₙ-Jₙ are arranged from the rear end side.

FIG. 5 is an explanatory perspective view of main portion between lines I₁-J₁ and I₁₃-J₁₃ of FIG. 2.

FIG. 6 is a set of process charts showing example steps of a spark plug manufacturing method according to the present invention.

FIG. 7 is an explanatory top view of a spark plug which is another embodiment of the spark plug of the present invention with the sectional images Sₙ thereof being superimposed.

FIG. 8 is an explanatory top view of a spark plug which is still another embodiment of the spark plug of the present invention with the sectional images Sₙ thereof being superimposed.

FIG. 9 is an explanatory top view of a spark plug which is still another embodiment of the spark plug of the present invention with the sectional images Sₙ thereof being superimposed.

### DETAILED DESCRIPTION OF THE INVENTION

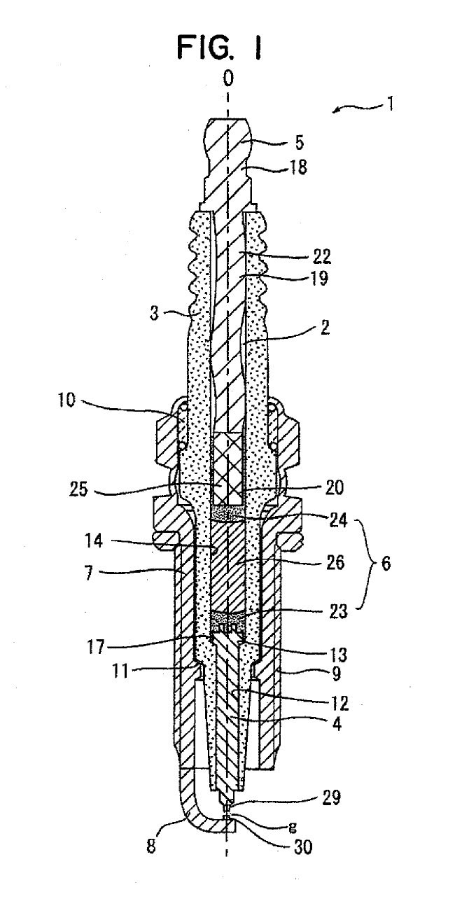

FIG. 1 shows a spark plug which is one embodiment of a spark plug according to the present invention. FIG. 1 is an explanatory sectional view showing the entirety of a spark plug 1 which is one embodiment of the spark plug according to the present invention. In FIG. 1, the axis of an insulator is denoted by O. In the following description, the lower side of the sheet on which FIG. 1 is drawn; i.e., the side where a center electrode is held, will be referred to as the forward end side along the axis O, and the upper side of the sheet on which FIG. 1 is drawn; i.e., the side where a metallic terminal is held, will be referred to as the rear end side along the axis O.

This spark plug 1 includes an insulator 3 which has an axial hole 2 extending in the direction of the axis O; a center electrode 4 which is held at the forward end of the axial hole 2; a metallic terminal 5 which is held at the rear end of the axial hole 2; a connecting portion 6 which electrically connects the center electrode 4 and the metallic terminal 5 within the axial hole 2; a metallic shell 7 which accommodates the insulator 3; and a ground electrode 8 whose one end is joined to a forward end surface of the metallic shell 7 and whose other end faces the center electrode 4 with gap formed therebetween.

The metallic shell 7 has a generally cylindrical shape and is formed to accommodate and hold the insulator 3. A threaded portion 9 is formed on the outer circumferential surface of a forward end portion of the metallic shell 7. The spark plug 1 is attached to the cylinder head of an unillustrated internal combustion engine through use of the threaded portion 9. The metallic shell 7 may be formed of an electrically conductive steel material such as low-carbon steel. Preferably, the threaded portion 9 has a size of M12 or less in order to decrease the diameter thereof.

The insulator 3 is held inside the metallic shell 7 via talc 10, a packing 11, etc. The axial hole 2 of the insulator 3 has a small-diameter portion 12 and an intermediate-diameter portion 14. The small-diameter portion 12 holds the center electrode 4 on the forward end side along the axis O. The intermediate-diameter portion 14 accommodates the connecting portion 6 and an accommodated portion 19 of the metallic terminal 5 which has a generally cylindrical columnar shape and which extends forward. The intermediate-diameter portion 14 is greater in diameter than the small-diameter portion 12, and is located adjacent to the small-diameter portion 12 via a step portion 13. The insulator 3 is fixed to the metallic shell 7 such that a forward end portion of the insulator 3 projects from the forward end surface of the metallic shell 7. The insulator 3 is desirably formed of a material which is sufficiently high in mechanical strength, thermal strength, electrical strength, etc. An example of such a material is a ceramic sintered body containing alumina as a main component.

The center electrode 4 is accommodated in the small-diameter portion 12 of the axial hole 2, and flange portion 17 provided at the rear end of the center electrode 4 and having a larger diameter is engaged with the step portion 13 of the axial hole 2. Thus, the center electrode 4 is held such that the forward end of the center electrode 4 projects from the forward end surface of the insulator 3, and the center electrode 4 is insulated from the metallic shell 7. The center electrode 4 is desirably formed of a material having a sufficient thermal conductivity, a sufficient mechanical strength, etc. For example, the center electrode 4 is formed of a nickel alloy such as Inconel (trademark). A core portion of the center electrode 4 may be formed of a metallic material which is excellent in thermal conductivity such as Cu or Ag.

The ground electrode 8 is formed into, for example, a generally prismatic shape. The ground electrode 8 is joined at its one end to the forward end surface of the metallic shell 7, and is bent in the middle to have a generally L-like shape. The shape and structure of the ground electrode 8 are designed such that its distal end portion faces a forward end portion of the center electrode 4 with a gap formed therebetween. The ground electrode 8 is formed of the same material as that of the center electrode 4.

Noble metal tips 29 and 30 formed of a platinum alloy, an iridium alloy, or the like may be respectively provided on the surfaces of the center electrode 4 and the ground electrode 8 which face each other. Alternatively, a noble metal tip may be provided on only one of the center electrode 4 and the ground electrode 8. In the spark plug 1 of the present embodiment, both the center electrode 4 and the ground electrode 8 have the noble metal tips 29 and 30 provided thereon, and a spark discharge gap g is formed between the noble metal tips 29 and 30.

The metallic terminal 5 is used to externally apply to the center electrode 4 a voltage for generating spark discharge between the center electrode 4 and the ground electrode 8. The metallic terminal 5 has an exposed portion 18 and the accommodated portion 19 having a generally circular columnar shape. The exposed portion 18 has an outer diameter greater than the diameter of the axial hole 2 and is exposed from the axial hole 2. A flange-shaped portion of the exposed portion 18 butts against the end surface of the insulator 3 located on the rear end side with respect to the direction of the axis O. The accommodated portion 19 extends forward from the end surface of the exposed portion 18 located on the forward end side with respect to the direction of the axis O, and is accommodated in the axial hole 2. The accommodated portion 19 has a fixing portion 25 and a trunk portion 22. The fixing portion 25 is located at a forward end 20 along the axis O, and has an uneven surface. The trunk portion 22 is located rearward of the fixing portion 25 along the axis O, and is located adjacent to the exposed portion 18. The fixing portion 25 and the trunk portion 22 are accommodated in the intermediate-diameter portion 14. In the spark plug of the present embodiment, the outer circumferential surface of the fixing portion 25 is knurled. Since the outer circumferential surface of the fixing portion 25 has an uneven structure formed by, for example, knurling, the degree of adhesion between the metallic terminal 5 and the connecting portion 6 increases. As a result, the metallic terminal 5 and the insulator 3 are firmly fixed together. The metallic terminal 5 is formed of, for example, low-carbon steel or the like, and a nickel layer is formed on the surface of the metallic terminal 5 through plating or the like.

The connecting portion 6 is disposed in the axial hole 2 such that it is located between the center electrode 4 and the metallic terminal 5, and electrically connects the center electrode 4 and the metallic terminal 5. The connecting portion 6 includes a resistor 26 and prevents generation of radio noise by the action of the resistor 26. The connecting portion 6 has a first seal layer 23 between the resistor 26 and the center electrode 4 and a second seal layer 24 between the resistor 26 and the metallic terminal 5. The first seal layer 23 and the second seal layer 24 fix the insulator 3, and the center electrode 4 and the metallic terminal 5 in a sealed condition.

The resistor 26 may be constituted by a resistor member formed by sintering a resistor composition which contains powder of glass such as borosillicate soda glass, powder of ceramic such as ZrO₂, electrically conductive nonmetallic powder such as carbon black, and/or powder of metal such as Zn, Sb, Sn, Ag, Ni, etc. The resistor 26 typically has a resistance of 100Ω or higher.

The first seal layer 23 and the second seal layer 24 may be constituted by a seal material which is formed by sintering a seal powder which contains powder of glass such as borosillicate soda glass and powder of metal such as Cu, Fe, etc. Each of the first seal layer 23 and the second seal layer 24 typically has a resistance of 100 mΩ or lower.

Since the first seal layer 23 and the second seal layer 24 contain the metallic component in an amount greater than in the resistor 26, these seal layers are disposed between the resister 26, and the center electrode 4 and the metallic terminal 5 so as to increase the joint strength therebetween. In the following description, the resistor member and the seal member constituting the connecting portion 6 may be collectively referred to as a connecting member, and the resistor composition and the seal powder used for forming the connecting portion 6 may be collectively referred to as connecting portion forming powder.

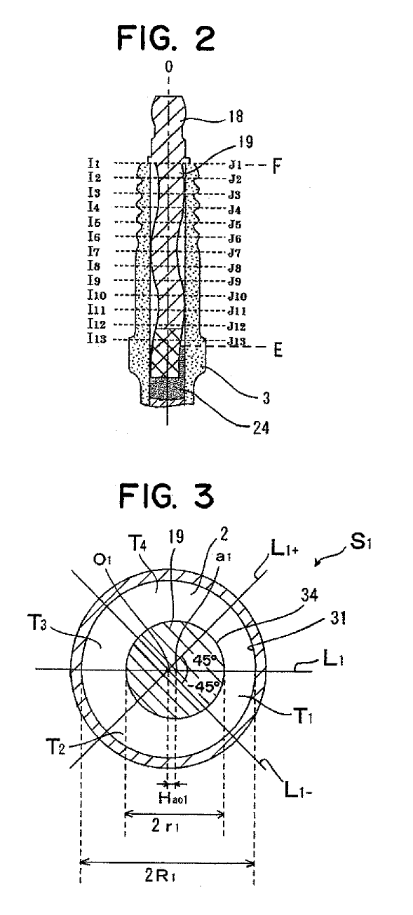

FIG. 2 is an explanatory sectional view for describing the characteristic portion of the spark plug of the present invention. Accordingly, FIG. 2 mainly shows the insulator and the metallic terminal of the spark plug, and the members disposed forward of the metallic terminal, the metallic shell, etc. are omitted.

As shown in FIG. 2, in the spark plug of the present invention, the accommodated portion 19 is bent in a wavy shape, and has a plurality of bent portions which are located in close vicinity to the inner circumferential surface of the axial hole 2 of the insulator 3. In the case where sectional images Sₙ orthogonal to the axis are captured, through use of a micro X-ray CT apparatus (e.g., TOSCANER-32250μhd), at intervals of 0.5 mm from the rear end F of the accommodated portion 19 (i.e., the boundary between the exposed portion 18 and the accommodated portion 19) toward the front end thereof up to a rear end position E at which the connection member is present, the sectional image Sₙ of the spark plug of the present invention has the following feature.

Line I₁-J₁ in FIG. 2 shows the position (in the direction of the axis O) of a sectional image S₁ which is first captured from the rear end side of the accommodated portion 19. In the present embodiment, 13 sectional images Sₙ in total are captured until a sectional image S₁₃ is captured at a position within a 0.5 mm range extending rearward from the rear end position E of the connection member. Notably, Sₙ represents that a sectional image denoted by Sₙ is the n-th sectional image counted from the rear end of the accommodated portion 19.

Accordingly, in the spark plug of the present embodiment, n is a natural number between 1 and 13. Since the sectional image is captured at intervals of 0.5 mm along the axial direction, the distance EF between the rear end F of the accommodated portion 19 (i.e., line I₁-J₁) and the position E at which the connection member is present falls within a range of 6 mm (the distance between line and I₁-J₁ and I₁₃-J₁₃) to 6.5 mm.

In the spark plug of the present invention, preferably, the distance EF between the rear end F of the accommodated portion 19 and the position E at which the connection member is present is 15 mm to 70 mm. In this case, the number of sectional images Sₙ to be obtained is 15/0.5 (decimals omitted)+1=31 to 70/0.5 (decimals omitted)+1=141. Notably, in order to facilitate description, FIG. 2 shows a spark plug of an embodiment in which the distance EF is smaller than 15 mm.

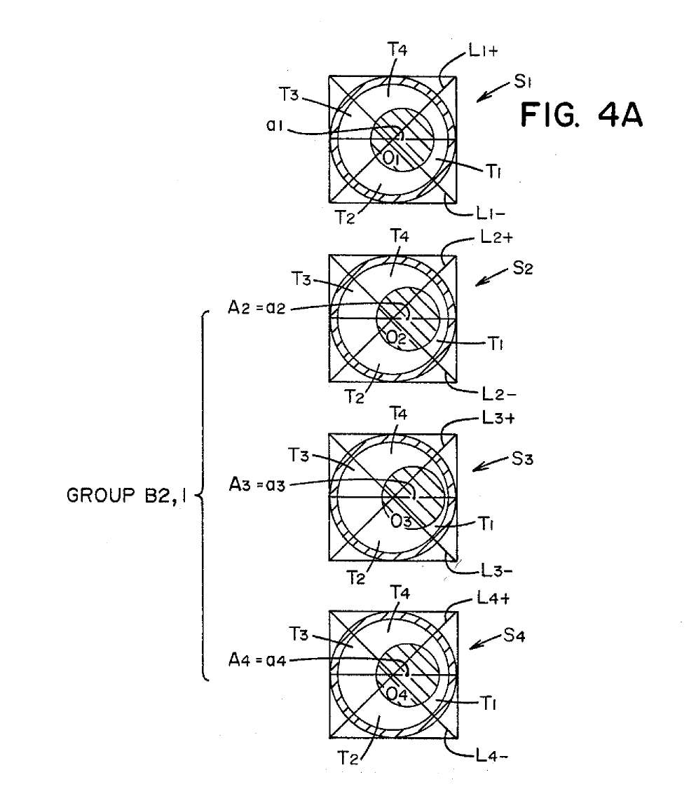

FIG. 3 is an explanatory view of the sectional image S₁ of the spark plug shown in FIG. 2 taken along line I₁-J₁.

In FIG. 3, a point a₁ represents the center of the accommodated portion 19 on the sectional image S₁; a point O₁ represents the center of the axial hole 2; a line L₁ represents a line which passes through the points a₁ and O₁; 2R₁ represents the diameter of the axial hole 2; 2r₁ represents the diameter of the accommodated portion 19, and Hₐₒ₁ represents the distance between the point a₁ and the point O₁. When a relation Hₐₒ₁≧0.8(R₁−r₁) is satisfied, the point a₁ is defined as a point A₁.

The point a₁ satisfies the above-mentioned relational expression when the point a₁ deviates from the point O₁ by a distance which is at least 80% of the distance (R₁−r₁) between the inner circumferential surface 31 of the insulator 3 and the outer circumferential surface 34 of the accommodated portion 19 measured in a state in which the point a₁ coincides with the point O₁. In the case where the point a₁ deviates from the point O₁ by an amount corresponding to the distance (R₁−r₁), the outer circumferential surface 34 of the accommodated portion 19 comes into contact with the inner circumferential surface 31 of the insulator 3. In the case where the accommodated portion 19 is bent such that the accommodated portion 19 approaches the inner circumferential surface 31 of the insulator 3 and the point a₁ is located at a position where the point a₁ satisfies the above-described relational expression, the point a₁ is defined as a point A₁.

In the sectional image S₁ in the present embodiment, as shown in FIG. 3, the point a₁ deviates from the point O₁ only slightly, and does not satisfy the above-described relational expression.

In the case of n=2 to 13 as well, like the case of n=1, a point aₙ, a point Oₙ, a line Lₙ, 2Rₙ, 2rₙ, Hₐₒₙ are defined. When the point aₙ satisfies the following relational expression on the sectional image Sₙ, the point aₙ is defined as a point Aₙ.

Hₐₒₙ≧0.8(Rₙ−rₙ) (1)

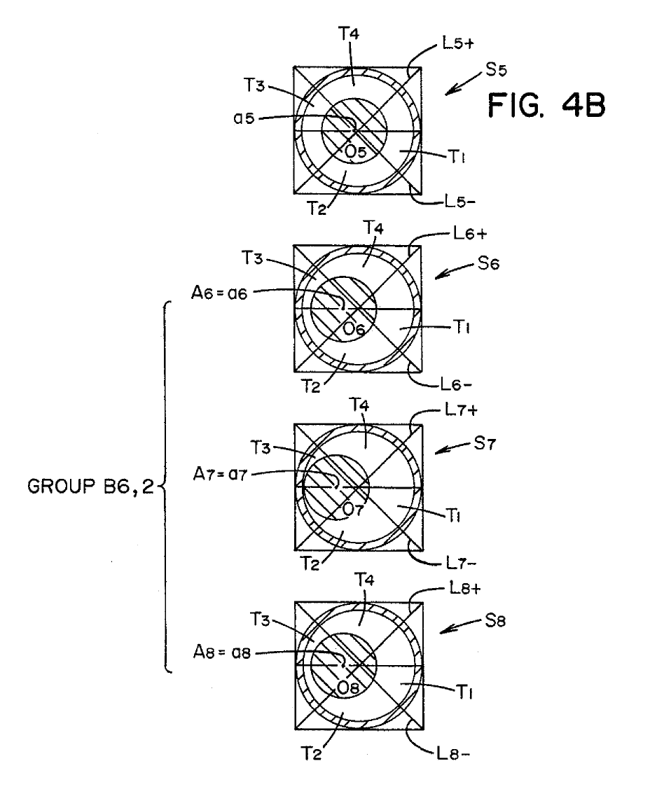

FIGS. 4A-4C are explanatory views showing sectional images in which the sectional images Sₙ of the spark plug shown in FIG. 2 taken along lines Iₙ-Jₙ are arranged from the rear end side. As shown in FIGS. 4A-4C, in the spark plug of the present embodiment, since the point aₙ on each of the sectional images S₂ to S₄, S₆ to S₈, and S₁₀ to S₁₂ satisfies the above-mentioned relational expression (1), the center points a₂ to a₄, a₆ to a₈, and a₁₀ to a₁₂ of the accommodated portion 19 are referred to as points A₂ to A₄, A₆ to A₈, and A₁₀ to A₁₂.

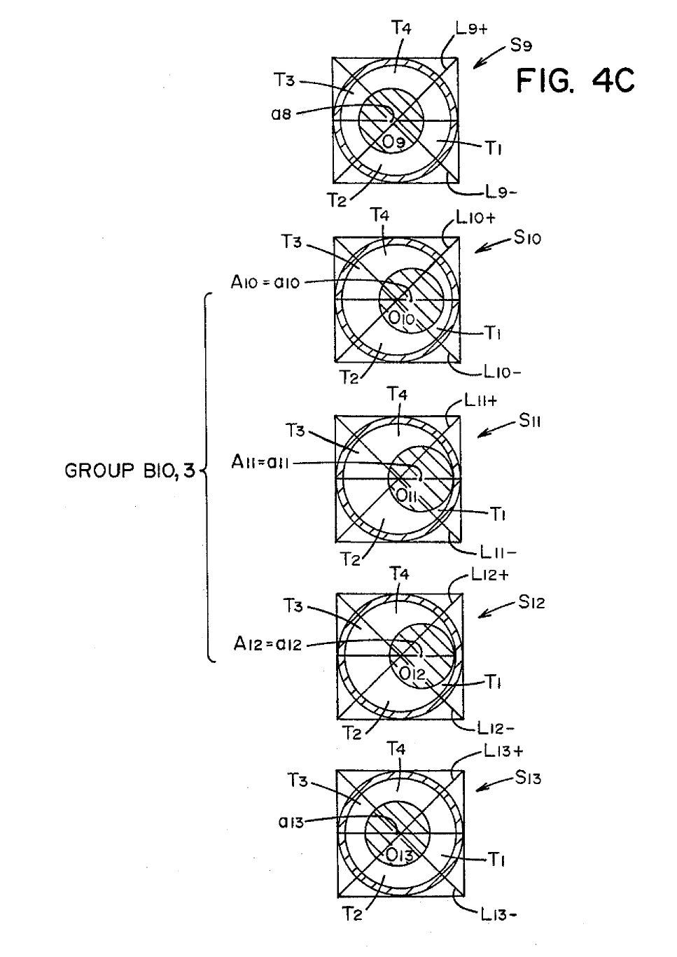

Next, FIG. 5 shows an explanatory perspective view of a main portion between lines I₁-J₁ and I₁₃-J₁₃ in FIG. 2. As shown in FIG. 3, a line which is obtained by rotating the line L₁ on the sectional image S₁ by 45° about the point O₁ is defined as a line L₁₊, and a line which is obtained by rotating the line L₁ by −45° about the point O₁ is defined as a line L₁₋. As shown in FIG. 5, four areas which are surrounded by a plane X₊ containing the line L₁₊ and the axis O, a plane X₋ containing the line L₁₋ and the axis O, and the inner circumferential surface 31 of the insulator 3 are identified by T₁, T₂, T₃, and T₄, respectively. In the present embodiment, the four areas are identified by T₁, T₂, T₃, and T₄, in this sequence in the clockwise direction, with the area in which the point a₁ is present being denoted by T₁.

In the case where successive points Aₘ to A₍ₘ₊ₖ₎ (m and k are natural numbers) are present in a specific area selected from the above-mentioned areas T₁ to T₄, a group containing these points Aₘ to A₍ₘ₊ₖ₎ is defined as a group B_{m,y} (notably, y is a natural number and means that the group is the y-th group counted from the rear end side of the accommodated portion). In other words, when a point aₘ on the sectional image Sₘ is located at a position where it satisfies the above-described relational expression (1), the point aₘ is defined as a point Aₘ; and when a point a₍ₘ₊₁₎ on the sectional image S₍ₘ₊₁₎ adjacently located forward of the sectional image Sₘ is located at a position where it satisfies the above-described relational expression (1), the point a₍ₘ₊₁₎ is defined as a point A₍ₘ₊₁₎. When the points aₘ to a₍ₘ₊ₖ₎ on two or more sectional images (the sectional image Sₘ to the sectional image S₍ₘ₊ₖ₎) successively satisfy the above-described relational expression (1), the points aₘ to a₍ₘ₊ₖ₎ are referred to as points Aₘ to A₍ₘ₊ₖ₎. When these points Aₘ to A₍ₘ₊ₖ₎ are present in a specific area selected from the above-mentioned areas T₁ to T₄, a group containing these points Aₘ to A₍ₘ₊ₖ₎ is defined as a group B_{m,y}.

As shown in FIGS. 4A-4C, since the points A₂, A₃, and A₄ on the successively captured sectional images S₂, S₃, and S₄ satisfy the above-mentioned relational expression (1) and are present in a single area T₁, group including these points is defined as a group B_{2,1}. Similarly, since the points A₆, A₇, and A₈ on the successively captured sectional images S₆, S₇, and S₈ satisfy the above-mentioned relational expression (1) and are present in a single area T₃, a group including these points is defined as a group B_{6,2}. Similarly, since the points A₁₀, A₁₁, and A₁₂ on the successively captured sectional images S₁₀, S₁₁, and S₁₂ satisfy the above-mentioned relational expression (1) and are present in a single area T₁, a group including these points is defined as a group B_{10,3}.

In the spark plug of the present embodiment, since the number of the groups B_{m,y} is 3, the maximum value of y is 3; and the groups B_{2,1} and B_{10,3} and the group B_{6,2} are present in the two areas T₁ and T₃, which are located at symmetrical positions with respect to the axis O.

In the structure of a conventional spark plug has the following drawback. When the spark plug receives an impact or vibration, only the rear end of the accommodated portion is fixed, and the accommodated portion vibrates vigorously within the axial hole in a state in which the fixed rear end serves as a fulcrum. In contrast, in the spark plug of the present embodiment, the maximum value of y in its sectional images Sₙ is 3, and two of the groups B_{m,y} are present in two area located at symmetrical positions in relation to the axis O. Therefore, when the spark plug 1 receives an impact or vibration, as shown in FIG. 5, the accommodated portion 19 has fulcrums at points b₁, b₂, and b₃ which belong to the groups B_{2,1}, B_{6,2}, and B_{10,3}, respectively, and which are in close vicinity to the inner circumferential surface of the insulator 3, whereby the accommodated portion 19 is prevented from vigorously vibrating within the axial hole 2. As a result, it is possible to prevent generation of a crack between the first seal layer 23, and the second seal layer 24 and the resistor 26, especially between the second seal layer 24 and the resistor 26, which crack would otherwise be generated as a result of vigorous vibration of the accommodated portion 19 within the axial hole 2. Thus, it is possible to prevent occurrence of a contact failure and prevent the resistance of the connecting portion 6 from increasing sharply. Therefore, there can be provided a spark plug which is excellent in load life performance even when it receives an impact or vibration.

Notably, even in the case where the points Aₘ to A₍ₘ₊ₖ₎ on the sectional image Sₘ to S₍ₘ₊ₖ₎ which are contained in the groups B_{m,y} are not present at positions where they satisfy the relational expression Hₐₒₙ=(Rₙ−rₙ); i.e., in the case where the points Aₘ to A₍ₘ₊ₖ₎ are not located at positions where the outer circumferential surface 34 of the accommodated portion 19 does not contact with the inner circumferential surface 31 of the insulator 3, there may be a case where a portion (e.g., the point b₃) other than the portion photographed as a sectional image Sₙ becomes the closest to the inner circumferential surface 31. Accordingly, in the case where the points Aₘ to A₍ₘ₊ₖ₎ contained in the groups B_{m,y} deviate from the center points Oₙ of the axial hole 2 by at least 80% of the distance (R₁−r₁), when the spark plug receives an impact or vibration, the circumferential surface 34 of the accommodated portion 19 can have portions (fulcrums) which come into contact with the inner circumferential surface 31 of the insulator 3. Thus, vigorous vibration of the accommodated portion 19 within the axial hole 2 can be prevented.

In the sectional images Sₙ of the spark plug of the present invention, the maximum value of y is at least 3, preferably at least 4, and most preferably at least 5. Although the maximum value changes depending on the length of the terminal, in general, the effect does not change when the maximum value becomes 20 or greater. Therefore, in general, the maximum value of y may be smaller than 20. The greater the value of y, the larger the number of bent portions which are formed on the accommodated portion and which are in close vicinity to the inner circumferential surface of the insulator; i.e., the larger the number of points at which the outer circumferential surface of the accommodated portion and the inner circumferential surface of the insulator come into contact with each other when the spark plug receives an impact. The greater the number of such points, the greater the degree to which vigorous vibration of the accommodated portion within the axial hole can be suppressed. Therefore, it is preferred to increase the number of such points to a possible degree.

In the sectional images Sₙ of the spark plug of the present invention, preferably, at least two of the groups B_{m,y} are present in two symmetrically located areas selected from the areas T₁ to T₄. Preferably, the groups B_{m,y} are present in three areas. More preferably, the groups B_{m,y} are present in all the areas. In the case where the bent portions of the accommodated portion located in close vicinity to the inner circumferential surface of the insulator (i.e., the points at which the outer circumferential surface of the accommodated portion and the inner circumferential surface of the insulator come into contact with each other when the spark plug receives an impact) are present at least at positions which are symmetrical with respect to the axis O, and preferably, are present evenly in the radial direction, vigorous vibration of the accommodated portion within the axial hole can be suppressed to a greater degree.

In the spark plug of the present invention, an inter-bend distance D, which is the distance (along the direction of the axis O) between a sectional image containing a point Aₛ (notably, the point Aₛ represents the first point Aₙ counted from the rear end of the accommodated portion 19) and a sectional image containing a point Aₑ (notably, the point Aₑ represents the last point Aₙ counted from the rear end of the accommodated portion 19), is preferably 5 mm or greater, more preferably 7 mm or greater, particularly preferably 10 mm or greater. Further, it is preferred that the distance D is equal to the length between the rear end of the accommodated portion and the rear end E of the connection member. When the inter-bend distance D is equal to or greater than a predetermined value, of the bent portions of the accommodated portion which are in close vicinity to the inner circumferential surface of the insulator, two bent portions located at opposite ends thereof separate from each other by a predetermined distance. Therefore, vigorous vibration of the accommodated portion within the axial hole can be suppressed to a greater degree.

In the spark plug of the present embodiment, the point Aₛ is the point A₂, and the point Aₑ is the point A₁₂. Since the sectional images are captured at intervals of 0.5 mm, the inter-bend distance D (along the direction of the axis O) between the sectional image S₂ and the sectional image S₁₂ is 5 mm.

In the spark plug of the present invention, when the diameter of the intermediate-diameter portion is 2.9 mm or less, load life performance in the case where the spark plug receives an impact or vibration can be improved further. The diameter of the intermediate-diameter portion is determined by measuring the diameter of the axial hole 2 at a position where the forward end portion of the metallic terminal 5 with respect to the direction of the axis O is disposed.

In general, the diameter (2rₙ) of the accommodated portion 19 of the spark plug of the present invention falls within a range of 70% to 97% of the diameter (2Rₙ) of the axial hole 2 of the insulator 3.

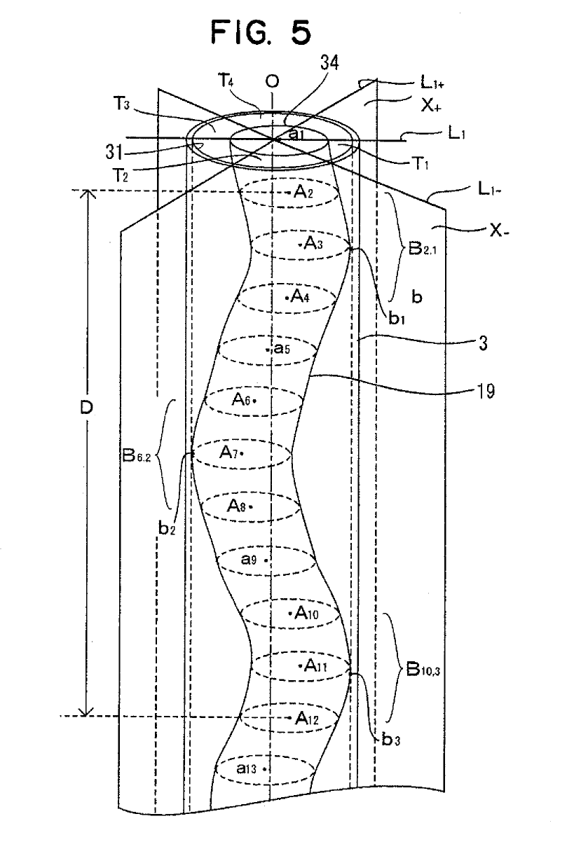

For example, the spark plug 1 is manufactured as follows. Of the steps for manufacturing the spark plug 1, the steps of disposing and fixing the insulator, the center electrode, and the metallic terminal will be mainly described (see FIG. 6).

First, the center electrode 4, the ground electrode 8, the metallic shell 7, the metallic terminal 5, and the insulator 3 are fabricated by known methods such that they have predetermined shapes (preparing step), and one end portion of the ground electrode 8 is joined to the forward end surface of the metallic shell 7 by laser welding or the like (ground electrode joining step).

Meanwhile, the center electrode 4 is inserted into the axial hole 2 of the insulator 3, and the flange portion 17 of the center electrode 4 is brought into engagement with the step portion 13 of the axial hole 2, whereby the center electrode 4 is disposed in the small-diameter portion 12 (first step).

Subsequently, a seal powder 15 which forms the first seal layer 23, a resistor composition 28 which forms the resistor 26, and a seal powder 16 which forms the second seal layer 24 are placed in this sequence into the axial hole 2 from the rear end thereof. Subsequently, a press pin 32 is inserted into the axial hole 2 so as to preliminarily compress them under a pressure of 60 N/mm² or greater. Thus, the seal powders 15, 16 and the resistor composition 28 are charged into the intermediate-diameter portion 14 (second step).

Subsequently, the forward end portion 20 of the metallic terminal 5 is inserted into the axial hole 2 from the rear end thereof, and the metallic terminal 5 is disposed such that the forward end portion 20 comes into contact with the seal powder 16 (third step).

Subsequently, a connection portion forming powder 27 is heated at a temperature equal to or higher than the glass softening point of the glass powder contained in the seal powders 15 and 16 (e.g., 800° C. to 1000° C.) for 3 min to 30 min. In this heated state, the metallic terminal 5 is pressed and inserted until the forward end surface of the exposed portion 18 of the metallic terminal 5 butts against the rear end surface of the insulator 3, whereby a load is applied to the connecting portion forming powder 27 (fourth step).

Thus, the seal powders 15, 16 and the resistor composition 28, which constitute the connecting portion forming powder 27, are sintered, whereby the first seal layer 23, the second seal layer 24, and the resistor 26 are formed. Also, the seal member which constitutes the first seal layer 23 and the second seal layer 24 is charged into the gap between the flange portion 17 and the wall surface of the axial hole 2 and between the forward end portion 20 and the wall surface of the axial hole 2. Thus, the center electrode 4 and the metallic terminal 5 are fixedly disposed in the axial hole 2 in a sealed condition. The above-described sectional images Sₙ are captured up to the rearmost end position at which the seal member is present.

Next, the insulator 3 including the center electrode 4, the metallic terminal 5, etc., fixed thereto is assembled to the metallic shell 7 having the ground electrode 8 joined thereto (assembly step).

Finally, a distal end portion of the ground electrode 8 is bent toward the center electrode 4 such that the distal end of the ground electrode 8 faces the forward end portion of the center electrode 4. Thus, the spark plug 1 is completed.

The spark plug of the present invention can be obtained by performing the above-described manufacturing method, while adjusting the composition of the material which constitutes the metallic terminal 5, adjusting the length and diameter of the accommodated portion 19, adjusting an exposure length (K), which is the axial length from the forward end of the exposed portion 18 to the rear end surface of the insulator 3 in the third step, changing the hardness (deformability) of the seal powder and/or the resistor composition, and changing the temperature of hot press in the fourth step.

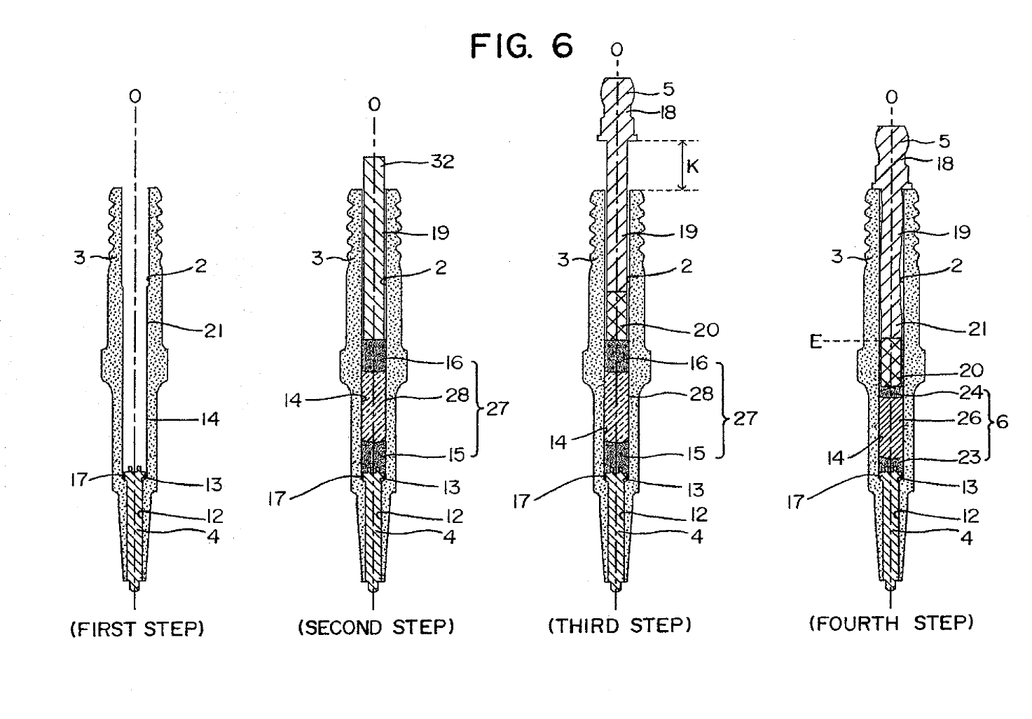

Spark plugs according to other embodiments of the spark plug of the present invention will be described with reference to FIGS. 7 to 9. Each of FIGS. 7 to 9 is an explanatory top view in which all the sectional images Sₙ are superimposed such that the sectional image S₁ is located at the top. In order to facilitate the description, the accommodated portion 19 and the metallic shell 7 on the sectional images located below the sectional image S₁ are not illustrated, and only the center point aₙ or Aₙ of the accommodated portion 19 is illustrated. In the discussion below, the position of the accommodated portion 19 in relation to the inner circumferential surface 31 of the axial hole 2 will be described. Also, in FIGS. 7 to 9, a circle which is centered at the axis O and which has the smallest radius is an imaginary line 33 which shows the position where the center point aₙ of the accommodated portion 19 satisfies a relational expression Hₐₒₙ=0.8(Rₙ−rₙ) (which represents the case where the left and right sides of the relational expression (1) are equal to each other). When the center point aₙ is located on the outer side of the imaginary line 33, the center point aₙ satisfies the above-mentioned relational expression (1), and when the center point aₙ is located on the inner side of the imaginary line 33, the center point aₙ does not satisfy the above-mentioned relational expression (1). In other words, in the case where the distance between the axis O and the center point aₙ of the accommodated portion 19 deviated therefrom is at least 80% of (Rₙ−rₙ), the center point aₙ is located on the outer side of the circle (or on the imaginary line 33). Meanwhile, in the case where the distance between the axis O and the center point aₙ of the accommodated portion 19 deviated therefrom is less than 80% of (Rₙ−rₙ), the center point aₙ is located on the inner side of the imaginary line 33. Notably, as described above, when the center point aₙ is located on the outer side of the circle or located on the imaginary line 33, the enter point aₙ is defined as the point Aₙ.

As shown in FIG. 7, a locus which connects the points aₙ on the sectional images Sₙ in the ascending order of the value of n has a spiral shape as viewed in plan. Since the sectional images Sₙ are captured at intervals of 0.5 mm, in the spark plug of this embodiment, the accommodated portion 19 bends spirally. In the spark plug of this embodiment, the point aₙ satisfies the above-mentioned relational expression (1) when the point aₙ of the accommodated portion 19 is located on the outer side of the circle or located on the imaginary line 33, and the points A₃ to A₁₂ satisfy the above-mentioned relational expression (1).

As described, when the successive points Aₘ to A₍ₘ₊ₖ₎ are present in a specific single area selected from the areas T₁ to T₄, the group including these points is defined as a group B_{m,y}. Therefore, the points A₄ and A₅ form a group B_{4,1}; the points A₆ to A₈ form a group B_{6,2}, the points A₉ and A₁₀ form a group B_{9,3}; and the points A₁₁ and A₁₂ form a group B_{11,4}. The group B_{4,1} is present in the area T₂; the group B_{6,2} is present in the area T₃; the group B_{9,3} is present in the area T₄; and the group B_{11,4} is present in the area T₁.

Accordingly, in the spark plug of the present embodiment, since the number of the groups B_{m,y} is four, the maximum value of y is four, and these groups B_{m,y} are present in all the areas T₁ to T₄.

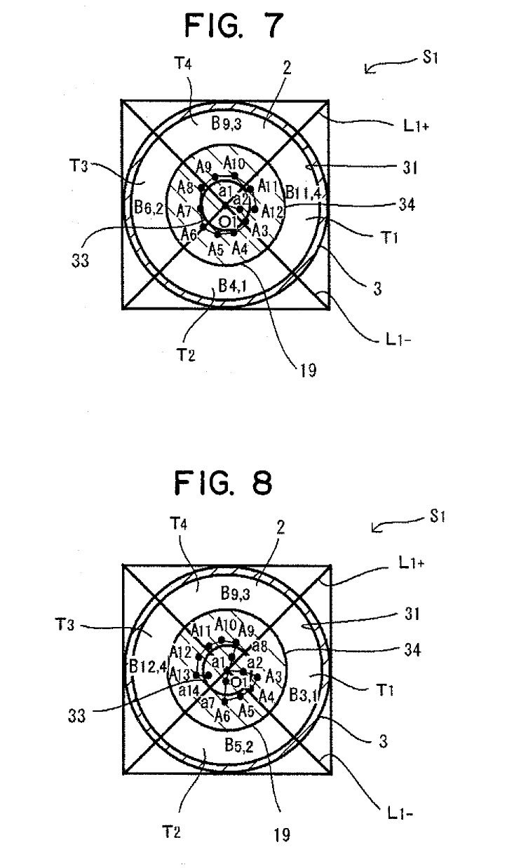

As shown in FIG. 8, a locus which connects the points aₙ on the sectional images Sₙ in the ascending order of the value of n has an 8-like shape as viewed in plan. Since the sectional images Sₙ are captured at intervals of 0.5 mm, in the spark plug of this embodiment, the accommodated portion 19 bends such that the accommodated portion 19 approaches a certain portion of the inner circumferential surface of the insulator, returns to the vicinity of the axis, and bends such that the accommodated portion 19 approaches another portion of the inner circumferential surface, which portion is located opposite the certain portion. In the spark plug of this embodiment, the point aₙ satisfies the above-mentioned relational expression (1) when the point aₙ of the accommodated portion 19 is located on the outer side of the circle or located on the imaginary line 33, and the points A₃ to A₆ and the points A₉ to A₁₃ satisfy the above-mentioned relational expression (1).

As described, when the successive points Aₘ to A₍ₘ₊ₖ₎ are present in a specific single area selected from the areas T₁ to T₄, the group including these points is defined as a group B_{m,y}. Therefore, the points A₃ and A₄ form a group B_{3,1}; the points A₅ and A₆ form a group B_{5,2}, the points A₉ to A₁₁ form a group B_{9,3}; and the points A₁₂ and A₁₃ form a group B_{12,4}. The group B_{3,1} is present in the area T₁; the group B_{5,2} is present in the area T₂; the group B_{9,3} is present in the area T₄; and the group B_{12,4} is present in the area T₃.

Accordingly, in the spark plug of the present embodiment, since the number of the groups B_{m,y} is four, the maximum value of y is four, and these groups B_{m,y} are present in all the areas T₁ to T₄.

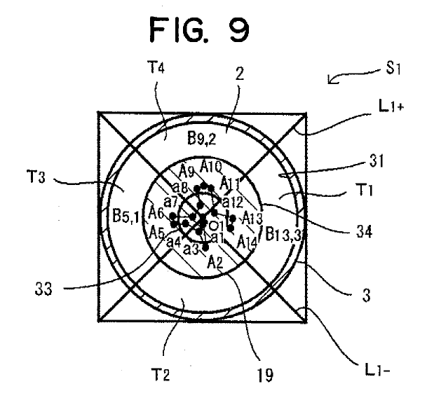

As shown in FIG. 9, a locus which connects the points aₙ on the sectional images Sₙ in the ascending order of the value of n has a star-like shape as viewed in plan. Since the sectional images Sₙ are captured at intervals of 0.5 mm, in the spark plug of this embodiment, the accommodated portion 19 bends to the vicinity of the inner circumferential surface of the insulator, returns to the vicinity of the axis, and repeats this bending pattern of bending to the vicinity of the inner circumferential surface of the insulator and returning to the vicinity of the axis. In the spark plug of this embodiment, the point aₙ satisfies the above-mentioned relational expression (1) when the point aₙ of the accommodated portion 19 is located on the outer side of the circle or located on the imaginary line 33, and the points A₂, A₅, A₆, A₉ to A₁₁, A₁₃, and A₁₄ satisfy the above-mentioned relational expression (1).

As described, when the successive points Aₘ to A₍ₘ₊ₖ₎ are present in a specific single area selected from the areas T₁ to T₄, the group including these points is defined as a group B_{m,y}. Therefore, the points A₅ and A₆ form a group B_{5,1}, the points A₉ to A₁₁ form a group B_{9,2}; and the points A₁₃ and A₁₄ form a group B_{13,3}. The group B_{5,1} is present in the area T₃; the group B_{9,2} is present in the area T₄; and the group B_{13,3} is present in the area T₁.

Accordingly, in the spark plug of the present embodiment, since the number of the groups B_{m,y} is three, the maximum value of y is three, and these groups B_{m,y} are present in three areas T₁, T₃, and T₄.

The spark plug according to the present invention is used as an ignition plug for an internal combustion engine (e.g., a gasoline engine) for automobiles. The above-mentioned threaded portion 9 is screwed into a threaded hole provided in a head (not shown) which defines and forms combustion chambers of the internal combustion engine, whereby the spark plug is fixed at a predetermined position. Although the spark plug according to the present invention can be used for any internal combustion engine, the spark plug is favorably used for an internal combustion engine in which the space for spark plugs is required to reduce, because the present invention provides a remarkable effect when it is applied to spark plugs having a reduced diameter.

The spark plug of the present invention is not limited to the above-described embodiment, and various modifications are possible within a range in which the object of the present invention can be achieved. For example, in the case of the spark plug 1, the knurled fixing portion 25 is provided at the forward end of the metallic terminal 5. However, no particular limitation is imposed on the method of processing the surface of the fixing portion 25 so long as the surface of the fixing portion 25 has a shape (e.g., an uneven shape) which enhances the adhesion between the fixing portion 25 and the seal member. For example, the surface of the fixing portion 25 may have a shape formed by threading or the like. Also, each of the entire outer circumferential surface and the entire forward end surface of the accommodated portion may have an uneven shape, and the entire surface of the accommodated portion may form the fixing portion. Alternatively, a portion of the surface of the accommodated portion may have an uneven shape.

### Example 1

### Manufacture of Spark Plug

The spark plug shown in FIG. 1 was manufactured in accordance with the above-described manufacturing process. Notably, there were manufactured spark plugs which were made different from one another in the number of groups B_{m,y} and the areas including the groups B_{m,y} by changing the axial length of the accommodated portion (accommodated portion length), the diameter of the axial hole of the insulator at the center-electrode-side forward end of the metallic terminal (the intermediate-diameter portion diameter), and the length (exposure length (K)) (along the direction of the axis O) from the forward end of the exposed portion to the rear end of the insulator in the third step.

Through use of a micro X-ray CT apparatus (e.g., TOSCANER-32250μhd), the sectional images Sₙ of each spark plug were captured at intervals of 0.5 mm from the rear end of the accommodated portion toward the forward end thereof up to the rear end position where the connection member is present, and the number of groups B_{m,y} and the areas (T₁ to T₄) including the groups B_{m,y}, and the inter-bend distance D were investigated on the basis of the sectional images Sₙ.

### Evaluation Method

### (Load Life Performance Test)

Each of the manufactured spark plugs was placed in an environment of 350° C., and a discharge voltage of 20 kV was applied thereto so as to generate discharge 3600 times over 1 min. The resistance R₀ of the resistor of each spark plug before this test and the resistance R₁ of the resistor after this test were measured. This test was carried out 10 times, and the time at which the ratio (R₁/R₀) of the average of the resistances R₁ after the test to the initial resistance R₀ became 1.5 or greater was measured. In consideration of the fact that the longer the above-mentioned time, the better the load life performance, the manufactured spark plugs were evaluated in accordance with the following criteria. The results of the evaluation are shown in Table 1 set forth below.

x: shorter than 150 hours

◯: 150 hours or longer

(Load Life Performance Test after Impact Resistance Test)

In accordance with JIS B 8031, an impact resistance test was performed for the manufactured spark plugs.

The spark plugs after having undergone the impact resistance test were tested in the same manner as in the above-described load life performance test, and were evaluated in accordance the following criteria. The results of the evaluation are shown in Table 1 set forth below.

1: shorter than 5 minutes

1.5: not shorter than 5 minutes but shorter than 20 hours

2: not shorter than 20 hours but shorter than 150 hours

2.5: not shorter than 150 hours but shorter than 180 hours

3 to 8.5: after 180 hours, 0.5 point was added every 20 hours

9: not shorter than 420 hours but shorter than 450 hours

9.5: not shorter than 450 hours but shorter than 500 hours

10: 500 hours or longer

TABLE 1

| | | | | | | | | Presence/ | | Results of |
|---|---|---|---|---|---|---|---|---|---|---|
| | | Diameter of | | | | | Number of | absence of | | load life |
| | | intermediate- | Length of | | Number | | areas | symmetry of | Results of | performance |
| | | diameter | accommodated | Exposure | of | Inter-bend | containing | areas | load life | test after |
| | | portion | portion | length K | groups | distance D | groups Bm, y | containing | performance | impact |
| No. | | (mm) | (mm) | (mm) | B_{m,y} | (mm) | (max: 4) | Bm, y | test | resistance test |
| 1 | Example | 2.7 | 33 | 13 | 8 | 10 | 4 | ◯ | ◯ | 10 |
| 2 | | 2.7 | 33 | 15 | 12 | 10 | 4 | ◯ | ◯ | 10 |
| 3 | Comparative | 2.7 | 33 | 9.5 | 1 | — | 1 | X | ◯ | 1 |
| 4 | Example | 2.7 | 33 | 10 | 2 | 5 | 1 | X | ◯ | 1 |
| 5 | | 2.7 | 33 | 10.5 | 3 | 5 | 2 | X | ◯ | 1 |
| 6 | Example | 2.7 | 33 | 10.5 | 3 | 4 | 2 | ◯ | ◯ | 2.5 |
| 7 | | 2.7 | 33 | 10.7 | 3 | 5 | 2 | ◯ | ◯ | 3 |
| 8 | | 2.7 | 33 | 10.7 | 3 | 6 | 2 | ◯ | ◯ | 4 |
| 9 | | 2.7 | 33 | 10.6 | 4 | 6 | 3 | ◯ | ◯ | 4.5 |
| 10 | | 2.7 | 33 | 11 | 4 | 7 | 3 | ◯ | ◯ | 5 |
| 11 | | 2.7 | 33 | 10.8 | 5 | 7 | 3 | ◯ | ◯ | 5.5 |
| 12 | | 2.7 | 33 | 11.2 | 5 | 7 | 4 | ◯ | ◯ | 6 |
| 13 | | 2.7 | 33 | 11.5 | 6 | 7 | 4 | ◯ | ◯ | 6.5 |
| 14 | | 2.7 | 33 | 11.7 | 6 | 8 | 4 | ◯ | ◯ | 7 |
| 15 | | 2.9 | 33 | 10.7 | 5 | 7 | 4 | ◯ | ◯ | 6 |
| 16 | | 2.9 | 33 | 10.8 | 6 | 8 | 4 | ◯ | ◯ | 7 |
| 17 | Comparative | 3.5 | 33 | 10.5 | 3 | 5 | 2 | X | ◯ | 1.5 |
| | Example | | | | | | | | | |
| 18 | Example | 3.5 | 33 | 10.5 | 3 | 5 | 2 | ◯ | ◯ | 3.5 |
| 19 | | 2.7 | 37 | 12.7 | 8 | 30 | 4 | ◯ | ◯ | 10 |
| 20 | | 2.7 | 45 | 12.7 | 10 | 37 | 4 | ◯ | ◯ | 10 |
| 21 | | 2.7 | 37 | 11.3 | 6 | 8 | 4 | ◯ | ◯ | 6.5 |
| 22 | | 2.7 | 37 | 11.7 | 6 | 10 | 4 | ◯ | ◯ | 10 |
| 23 | | 2.7 | 45 | 10.9 | 6 | 8 | 4 | ◯ | ◯ | 6.5 |
| 24 | | 2.7 | 45 | 11.3 | 6 | 10 | 4 | ◯ | ◯ | 10 |
| 25 | | 2.5 | 38 | 11.2 | 7 | 6 | 3 | ◯ | ◯ | 4.5 |
| 26 | | 2.5 | 38 | 11.5 | 7 | 8 | 4 | ◯ | ◯ | 7 |
| 27 | | 2.5 | 38 | 11.8 | 10 | 10 | 4 | ◯ | ◯ | 10 |
| 28 | | 2.1 | 38 | 11.4 | 7 | 6 | 3 | ◯ | ◯ | 4.5 |
| 29 | | 2.1 | 38 | 11.5 | 7 | 8 | 4 | ◯ | ◯ | 7 |
| 30 | | 2.1 | 38 | 11.7 | 10 | 10 | 4 | ◯ | ◯ | 10 |
| 31 | | 2.9 | 33 | 10.5 | 3 | 5 | 2 | X | ◯ | 1 |
| 32 | | 2.9 | 33 | 10.7 | 3 | 5 | 2 | ◯ | ◯ | 3 |

As shown in Table 1, the spark plugs falling inside the range of the invention were excellent in the results of the load life performance test and the results of the load life performance test performed after the impact resistance test. In contrast, the spark plugs falling outside the range of the invention were poor in the results of the load life performance test performed after the impact resistance test although they were excellent in results of the load life performance test.

### DESCRIPTION OF REFERENCE NUMERALS

1: spark plug
2: axial hole
3: insulator
4: center electrode
5: metallic terminal
6: seal portion
7: metallic shell
8: ground electrode
9: threaded portion
10: talc
11: packing
12: smaller-diameter portion
13: step portion
14: intermediate-diameter portion
15, 16: seal powder
17: flange portion
18: exposed portion
19: accommodated portion
20: forward end portion
22: trunk portion
23: first seal layer
24: second seal layer
25: fixing portion
26: resistor
27: connecting portion forming powder
28: resistor composition
29, 30: noble metal tip
31: inner circumferential surface
32: press pin
33: imaginary line
34: outer circumferential surface

Having described the invention, the following is claimed:

1. A spark plug comprising:
an insulator having an axial hole extending in a direction of an axis;
a center electrode held at one end of the axial hole;
a metallic terminal which has an accommodated portion accommodated in the axial hole and which is held at the other end of the insulator; and
a connecting portion which electrically connects the center electrode and the metallic terminal within the axial hole, wherein:
the side of the axial hole where the metallic terminal is held is defined as a rear end side with respect to the direction of the axis;
a connection member which constitutes the connecting portion is provided between an outer circumferential surface of a forward end portion of the accommodated portion and an inner circumferential surface of the insulator; and
in sectional images orthogonal to the axis which are captured at intervals of 0.5 mm from a rear end of the accommodated portion toward a forward end thereof up to a rear end position where the connection member is present,
on a sectional image Sₙ at the n-th section, n being a natural number, counted from the rear end of the accommodated portion,
a center of the accommodated portion is defined as a point aₙ, a center of the axial hole is defined as a point Oₙ, a line which passes through the points aₙ and Oₙ is defined as a line Lₙ, a diameter of the axial hole is represented by 2Rₙ, a diameter of the accommodated portion is represented by 2rₙ, a distance between the point aₙ and the point Oₙ is represented by Hₐₒₙ, and the point aₙ which satisfies a relation Hₐₒₙ≧0.8(Rₙ−rₙ) is defined as a point Aₙ,
on the sectional image S₁,
a line which is obtained by rotating a line L₁ by 45° about the point O₁ is defined as a line L₁₊, a line which is obtained by rotating the line L₁ by −95° about the point O₁ is defined as a line L₁₋, four areas which are surrounded by a plane X₊ containing the line L₁₊ and the axis, a plane X₋ containing the line L₁₋ and the axis, and the inner circumferential surface of the insulator are areas T₁, T₂, T₃, and T₄, respectively, and
when successive points Aₘ to A₍ₘ₊ₖ₎, m and k being natural numbers, are present in a specific area selected from the areas T₁, T₂, T₃, and T₄, a group containing these points Aₘ to A₍ₘ₊ₖ₎ is defined as a group B_{m,y}, where y is a natural number and means that the group is the y-th group counted from the rear end side of the accommodated portion,
wherein the maximum value of y is at least 3, and at least two of the groups B_{m,y} are present in two areas which are selected from the areas T₁ to T₄ and which are located at symmetrical positions.

2. A spark plug according to claim 1, wherein an inter-bend distance D, which is a distance along the direction of the axis between a sectional image containing a point Aₛ, which is the first point Aₙ counted from the rear end of the accommodated portion, and a sectional image containing a point Aₑ, which is the last point Aₙ counted from the rear end of the accommodated portion, is 5 mm or greater.

3. A spark plug according to claim 1 wherein the groups B_{m,y} are present in at least three areas selected from the areas T₁ to T₄.

4. A spark plug according to claim 1, wherein the maximum value of y is at least 4.

5. A spark plug according to claim 1, wherein the groups B_{m,y} are present in all the areas T₁ to T₄.

6. A spark plug according to claim 1, wherein the maximum value of y is at least 5.

7. A spark plug according to claim 1, wherein an intermediate-diameter portion diameter, which is a diameter of the axial hole at a position where the forward end portion is disposed, is 2.9 mm or less.

8. A spark plug according to claim 1, wherein the inter-bend distance D is 7 mm or greater.

9. A spark plug according to claim 1, wherein the inter-bend distance D is 10 mm or greater.
